(19) United States
(12) Patent Application Publication
(10) Pub. No.: US 2002/0029175 A1
(43) Pub. Date: Mar. 7, 2002

(54) Method and system for performing commodity purchasing

(75) Inventors: Kazuhiro Yabuta, Kanagawa-ken (JP); Masaaki Ishibashi, Kanagawa-ken (JP); Takashi Ishii, Yokohama-shi (JP)

Correspondence Address: A. Bruce Clay, IBM Corporation T81/503, PO Box 12195, Research Triangle Park, NC, 27709, US

(73) Assignee: International Business Machines Corporation, Armonk, NY (US)

(21) Appl. No.: 09/900,265

(22) Filed: Jul. 6, 2001

(30) Foreign Application Priority Data
Jul. 13, 2000 (JP) 2000-212455

(51) Int. Cl. G06F 17/60

(52) U.S. Cl. 705/27

(57) ABSTRACT

Commodities may be purchased through a network by sending a request from a computer or a cellular phone. An identifier corresponding to an identification code of the cellular phone is included in the phone request. By analyzing a connection request, it is determined whether or not the identifier is included. Different session control is executed depending on whether the identifier is included or not.

### FIELD OF THE INVENTION

The present invention relates to a system and method for purchasing commodities through a network, and computer-readable storage medium containing a program for performing the commodity purchasing method.

### BACKGROUND OF THE INVENTION

Today, as a result of the advances of networks and computers, commodity purchasing systems have been widely accepted, which allow consumers, the users of the commodity purchasing systems, to place an order for and receive commodities on their computers through a network.

In a conventional commodity purchasing system, a user at a computer connected to a network such as the Internet accesses a server located at the site of a commodity provider through browser software to browse a commodity catalog, select a commodity from the catalog, and purchase it.

The server, which receives a signal sent from the purchaser's computer, typically performs the session control of accesses to the server through the network by using a mechanism, called a “cookie”, with which the server identifies and manages users. FIG. 1 shows an example of the session control using a conventional cookie as a communication history between a computer located at a user site and a server.

In FIG. 1, the state of history information on the user's computer is parallelized to the phase of accesses to the server from the user's computer. FIG. 1a shows the state of the communication of history information between the server and the user's computer, and FIG. 1b shows the access phases between the server and the user's computer.

As shown in FIG. 1b, an access to the server starts at step 101, where the computer at the user site activates browser software. In this state, as shown in FIG. 1a, no cookies, which are used as history information, are recorded in the computer at the user site. Then the computer at the user site executes a login to the server at step 102. The computer at the user site then sends a user ID (which is a signal previously provided to the user) to identify the user to the server along with other signals such as a password for login, PWD. The server, which received the user ID and password PWD, stores the last login time and sends a cookie to the computer at the user site. The cookie returned by the server at step 102 is encrypted information,, for example, RTz+HDYHG5M . . . This code is sent from the user's computer to access the server when it accesses the server at step 103 and decodes into information, “xxx logged in to the server at yyyy-MM-DD HH:MM:SS”, by appropriate means included in the server to allow the server to determine the login status. The cookie at step 103 is kept in storage on the client computer and the server and is communicated between them for session control until the computer at the user site terminates the browser software in response to the user's operation at step 104.

When the browser software is terminated at step 104, the cookie, which has been used until then, is deleted and no history information, including the cookie, exists. When the computer at the user site activates the browser software again at step 105 and sends the user ID and password, PWD, to the server to log in to the server at step 106, the server updates the last login time, invalidates the cookie issued during the previous login, and returns a newly issued cookie, which is encrypted information , for example, such as VaAVcHDFsa . . . to the computer at the user site. The new cookie is stored for session control while the session newly initiated at step 106 is being performed.

FIG. 2 is a block diagram outlining the control of sessions between the server and the computer at the user site shown in FIG. 1. The user activates the browser software on the computer at the user site and sends an HttpReq to the server over the Internet. The server, which received the HttpReq, executes a commodity purchase command and returns a response, HttpRes, which is the result of the execution, to the client computer at the user site. This series of sessions is controlled by a session control program shown in FIG. 2 which issues history information such as cookies to control sessions. The terms, “HttpReq” and “HttpRes”, used herein refer to a connection request and a corresponding response which are sent and received between a cellular phone or computer and a server by using object-oriented programming conforming to the HTTP protocol between the server and the browser software as well as the cellular phone.

FIG. 3 shows the server process (the commodity purchase command in FIG. 2). An HttpReq issued by the computer at the user site is received at step 301. The HttpReq may be https://hostname/cgi-bin/ncommerce3/login?name=is 1 password=isel, for example. The server, which received the HttpReq, executes Server.exe to initiate a real process for purchasing commodities through the network at step 302. Then, in TRANS_INIT(Cookie) at step 303, it is determined whose authority, which is set up for the access from the computer at the user site, is used to execute the command. The execution of the command without execution authority is suppressed to prevent an unauthorized access. A cookie is communicated between the server and the computer at the user site to control the access status.

If it is determined that the command is from an authorized user, at step 304, the requested command is executed by using the authority of the requesting user. Then in TRANS_END at step 305, a change made to a database is committed or rolled back depending on the result of the execution of the command. Then at step 306, the server returns an HttpRes to the computer at the user site and repeats the server process initiated by an HttpReq.

Conventionally, session control is accomplished by providing history information such as a cookie to a server and a computer at the user site as described above, allowing the purchase of commodities over a network. Recently, services provided over a network such as the Internet have become available on a cellular phone. It is estimated that over six million such cellular phones currently allow access to the Internet. Therefore, it would be very effective if the user of a cellular phone could access a network, such as the Internet, to purchase commodities.

Since cellular phone browsers cannot store history information, such as a cookie, a party that provides an electronic commodity-purchasing service site (hereinafter referred to as an EC site) over a network, or a party that already has an EC site for computer users, has to provide a separate EC site for cellular phones in addition to the existing Web-based EC site for computers. Additionally, only one commodity could be purchased at a time. Since the commodity purchasing system for cellular phone was different from an existing commodity purchasing system using a computer browser, a database could not be shared between these systems, such that the user of a cellular phone and the user of a computer could not purchase commodities in the same commodity purchasing system.

### SUMMARY OF THE INVENTION

It is an object of this invention to provide a commodity purchasing system and method that allow the user of a computer and the user of a cellular phone to use the same system and method through a network such as the Internet. It is another object of this invention to provide a computer-readable recording medium on which a program is stored for performing the above-mentioned novel commodity purchasing method.

The commodity purchasing system of this invention is a system for purchasing commodities through a network, wherein the system comprises means for receiving a connection request sent from a computer and a connection request which is sent from a cellular phone and includes an identifier corresponding to the identification code of the cellular phone, wherein the means for receiving the connection request comprises: means for determining whether the identifier is included or not; and means for executing different session controls depending on whether the identifier is included or not.

In the commodity purchasing system of this invention, the means for receiving the connection request comprises a database containing, as user information, the identifier and status information associated with the identifier which is used apart from history information, such as with a cookie, allowing session control to be performed without a cookie. In the commodity purchasing system of this invention, the means for executing different session control by using history information communicated between the system and the computer if it is determined that the identifier is not included, or executes session control by using the identifier and the user status information associated with the identifier if it is determined that the identifier is included.

In the commodity purchasing system of this invention, the network comprises a first network for transmitting the connection request from the computer and a second network for transmitting the connection request from the cellular phone. The identifier corresponding to the identification code is added to the connection request from the cellular phone by means connected between the first network and the second network.

The commodity purchasing method of this invention is a method for purchasing commodity through a network, comprising the steps of: receiving a connection request sent from a computer and a connection request which is sent from a cellular phone and includes an identifier corresponding to the identification code of the cellular phone; determining whether the identifier is included or not; storing the identifier and user status information associated with the identifier in a database contained in means for receiving the connection request; and executing different session control depending on whether the identifier is included or not. The above-mentioned database contains as user information, the identifier and status information associated with the identifier which is used apart from history information such as a cookie, allowing session control to be performed without a cookie.

In the commodity purchasing method of this invention, the step of executing different session control is accomplished by using history information communicated between the system and the computer if it is determined that the identifier is not included, or executes session control by using the identifier and the user status information associated with the identifier if it is determined that the identifier is included. In the commodity purchasing method of this invention, the network comprises a first network for communicating with the computer and a second network for communicating with the cellular phone, and the method comprises the step of sending the connection request from the cellular phone through the second network.

The commodity purchasing method of this invention comprises the step of adding the identifier corresponding to the phone number to the connection request sent from the cellular phone. This identifier is added to the connection request by means connected between the first network and the second network.

The recording medium of this invention is a computer-readable recording medium on which a program is recorded for performing a method for purchasing commodities through a network, wherein the method comprises the steps of: receiving a connection request sent from a computer and a connection request which is sent from a cellular phone and includes an identifier corresponding to the identification code of the cellular phone; determining whether the identifier is included or not; storing the identifier and user status information associated with the identifier in a database contained in means for receiving the connection request; and executing different session control depending on whether the identifier is included or not.

In the recording medium of this invention, the step of executing different session control uses history information communicated between the system and the computer if it is determined that the identifier is not included, or uses the identifier and the user status information associated with the identifier if it is determined that the identifier is included. In the recording medium of this invention, the network comprises a first network for communicating with the computer and a second network for communicating with the cellular phone and the cellular phone sends the connection request through the second network. The identifier corresponding to the identification code is added to the connection request from the cellular phone by means connected between the first network and the second network.

### BRIEF DESCRIPTION OF THE DRAWINGS

For a more complete understanding of the present invention and the advantages thereof, reference is now made to the Detailed Description taken in conjunction with the attached Drawings, in which:

FIG. 1 shows a conventional session control in a commodity purchasing system over a network;

FIG. 2 shows a block diagram of the session control shown in FIG. 1;

FIG. 3 shows a flowchart of command execution in the commodity purchasing system through the network;

FIG. 4 shows a general block diagram of a commodity purchasing system according to this invention;

FIG. 5 shows a detailed block diagram of the commodity purchasing system according to this invention;

FIG. 6 shows how a cellular phone accesses an EC server by using the commodity purchasing system according to this invention;

FIG. 7 shows a look-up table containing user information stored in a database within the EC server according to this invention;

FIG. 8 shows a server process performed in the EC server according to this invention;

FIG. 9 shows a pseudo code for performing session control by identifier determination performed in the EC server according to this invention;

FIG. 10 shows the process flow of the commodity purchasing system according to this invention;

FIG. 11 shows an example of a cellular phone used with this invention;

FIG. 12 shows an embodiment of a screen provided by the commodity purchasing system according to this invention;

FIG. 13 shows another embodiment of a screen provided by the commodity purchasing system according to this invention;

FIG. 14 shows yet another embodiment of a screen provided by the commodity purchasing system according to this invention;

FIG. 15 shows yet another embodiment of a screen provided by the commodity purchasing system according to this invention;

FIG. 16 shows yet another embodiment of a screen provided by the commodity purchasing system according to this invention;

FIG. 17 shows yet another embodiment of a screen provided by the commodity purchasing system according to this invention;

FIG. 18 shows yet another embodiment of a screen provided by the commodity purchasing system according to this invention; and

FIG. 19 shows yet another embodiment of a screen provided by the commodity purchasing system according to this invention.

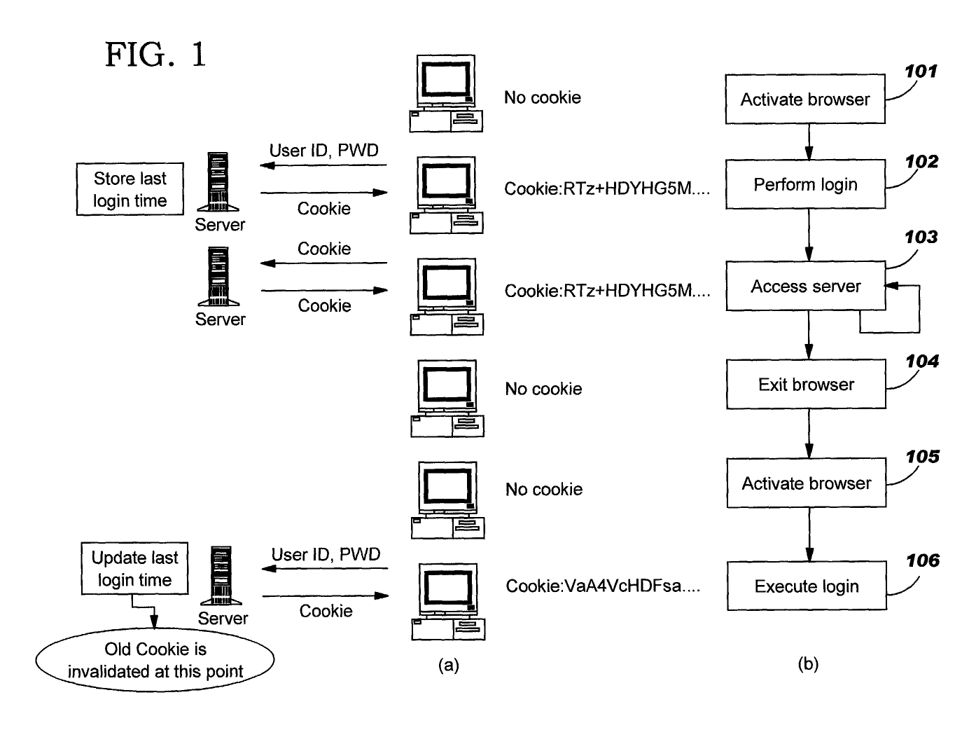

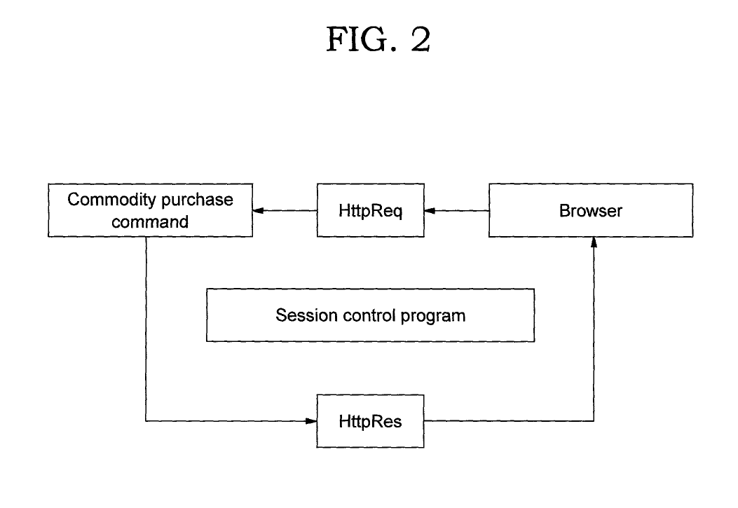

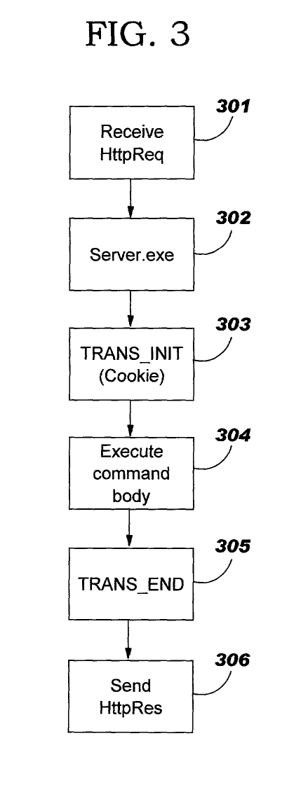

### DETAILED DESCRIPTION OF THE INVENTION

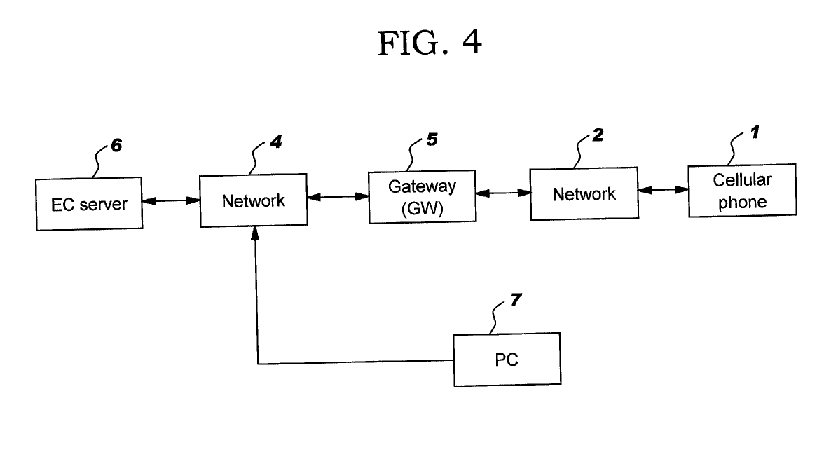

While this invention will be described with respect to embodiments shown in the accompanying drawings, this invention is not limited to those embodiments. FIG. 4 is a block diagram generally showing a commodity purchasing system according to this invention. This invention allows the user of a cellular phone 1 and the user of a computer 7 to access the same EC server 6 over a network 4 such as the Internet. The user of the cellular phone 1 first accesses a gateway 5 through a network 2 for the cellular phone 1. The gateway 5 adds to an HttpReq from the cellular phone 1 an identifier corresponding to an identification code, for example, a telephone number of the cellular phone 1, in one-to-one correspondence. The identification code is not limited to the telephone number of the cellular phone 1, and any other identification code can be used that are assigned to terminals such as the cellular phone 1 in one-to-one correspondence. The HttpReq to which the identifier is given is sent to the EC server 6 located at an EC site through the network 4 such as the Internet.

The user of the computer 7, which may be a personal computer, can access the EC server 6 connected to the network 4, which may be the Internet, through the network 4, as conventional. The EC server 6 includes means for determining whether an HttpReq contains an identifier or not, and, if the HttpReq does not contains any identifier, executing session control using a conventional cookie, or, if the HttpReq does contain an identifier, executing session control using the identifier by determining that the HttpReq has been sent from the user of a cellular phone.

Any computers known previously may be used as the EC server 6 and computer 7. In particular, examples of these include, but are not limited to, a personal computer, workstation, and general-purpose mainframe computer on which a CPU such as Pentium (a trademark of Intel Co.) or other CPUs compatible with Pentium can be installed and an operating system such as Windows (a trademark of Microsoft Corporation), Windows NT (a trademark of Microsoft Corporation), OS/2 (a trademark of International Business Machines Corporation), AIX (a trademark of International Business Machines Corporation), UNIX, and Linux can run.

The network used with this invention may be a network such as the Internet. Other networks may be those using an appropriate communications protocol, for example a local area or wide area network using TCP/IP and a network using optical communications. The network that transfers a signal from the cellular phone 1 in this invention may be a dial-up line such as a wireless link for a cellular phone.

Any telephone system, including a cellular phone system supporting, for example, iMode, that allows a cellular phone to send an HttpReq through a network and allows the sent HttpReq to access a network such as the Internet may be used.

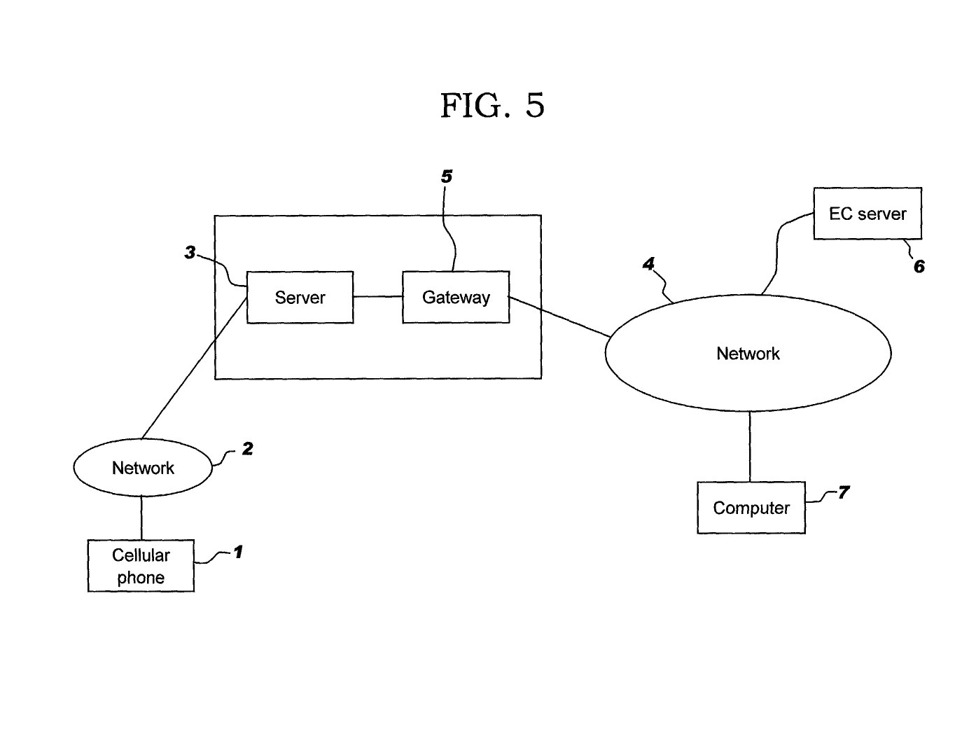

FIG. 5 is a block diagram showing the commodity purchasing system according to this invention. The commodity purchasing system of this invention comprises a cellular phone 1, a cellular phone network 2 for communicating the signal of the cellular phone 1, a server 3 for processing an HttpReq from the cellular phone, and a gateway 5 for coupling the HttpReq from the cellular phone 1 to a network 4 such as the Internet. An EC server 6 for purchasing commodities and a computer 7 such as a personal computer located at a user site are connected to the network 4, such as the Internet, to allow an HttpReq from the cellular phone 1 and an HttpReq from the computer 7 to be processed using the same database. While the server 3 and the gateway 5 are shown separately in FIG. 5, it is to be understood that they may be collocated at a workstation or computer.

An HttReq, “http://host/cgi-bin/some_cgi/?uid=NULLGWXXXXX”, for example, is received from the cellular phone 1, NULLGWXXXXX is replaced with a unique identifier, 00aaBBccDDee for example, which is predetermined for each terminal, and the unique identifier is assigned to the HttpReq from the cellular phone 1. This identifier is not limited to the construction provided above. Any digits, characters, or combinations thereof may be used in this identifier, as required. Furthermore, an identifier may be simply added the HttpReq without replacing with the above-above mentioned identifier, if possible in this invention. While a request in GET format is provided herein, the identifier in POST format may also be used. The EC server 6 can support any of these formats.

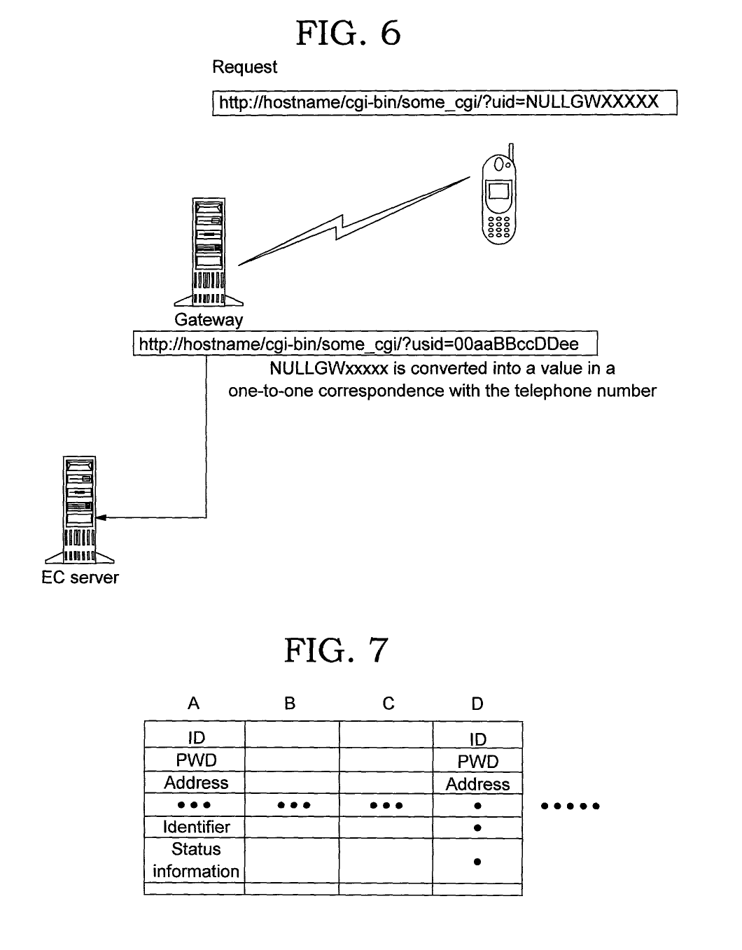

FIG. 6 shows how a cellular phone 1 accesses an EC server 6 through a gateway 5 and then through a network 4 such as the Internet.

FIG. 7 shows user information constructed in a database stored in the EC server 6. In the database, fields are provided for storing user information, including a user ID, password (PWD), and address, as well as an identifier assigned to the cellular phone 1 and status information about a user associated with the identifier. The status information herein refers to information indicating whether the user is in the login state or logoff state. Shown in FIG. 7 is an example in which users A to C are the users of a cellular phone 1 and user D is the user of a personal computer.

When the EC server 6 receives an HttpReq from the cellular phone 1, the EC server 6 determines whether the HttpReq is provided with an identifier or not to determine whether the user is accessing through a computer 7 or the cellular phone 1. The EC server 6 provides services using history information such as a cookie to a user accessing through the computer 7, or uses an identifier and status information associated with the identifier to perform a different session control process for a user accessing through a cellular phone 1. Thus, the same commodity purchasing service can be provided to the user of the cellular phone 1 and the user of the computer 7.

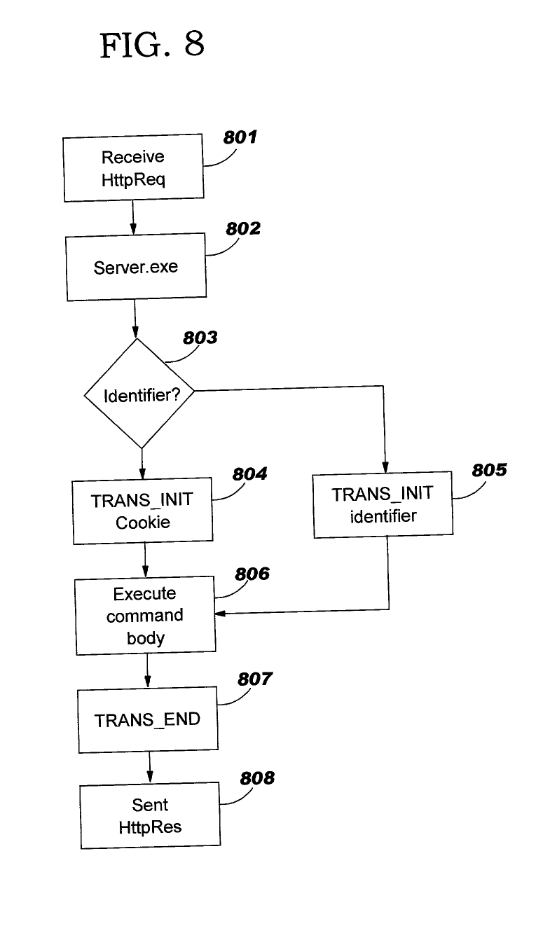

FIG. 8 shows a flowchart of a session control process performed by the EC server 6 of this invention. In the session control process performed by the EC server 6, an HttpReq is received from a user at step 801. An HttpReq sent from a cellular phone 1 to which an identifier is assigned and an HttpReq from a computer 7, such as a personal computer, are sent as the HttpReq. When the EC server 6 receives the HttpReq, it initiates a commodity purchasing service for each user using a program, which may be Server.exe for example, for commodity purchasing at step 802. An example of such a program may be a server program for commodity transactions, named Net.Commerce, from IBM Corporation.

Then the EC server 6 determines whether the HttpReq contains an identifier at step 803. If the EC server determines that no identifier is contained at step 803, it assumes that the HttpReq is sent from a computer 7 and executes initialization, TRANS_INIT(Cookie), for performing session control using history information such as a cookie at step 804. On the other hand, if the EC server determines that an identifier is contained, it assumes that the HttpReq is sent from a cellular phone 1 and executes initialization, TRANS_INIT(identifier), for performing session control without a Cookie at step 805.

Then the EC server 6 executes a command from the user by using the user's authority at step 806, and commits or rollsback the result of the execution, depending upon the command from the user to a database at step 807. Then the EC server 6 returns a response, HttpRes, corresponding to the HttpReq to the user, thus providing session control appropriate for the user and allowing the same commodity purchasing system to be used for the user of the cellular phone 1 and the user of the computer 7.

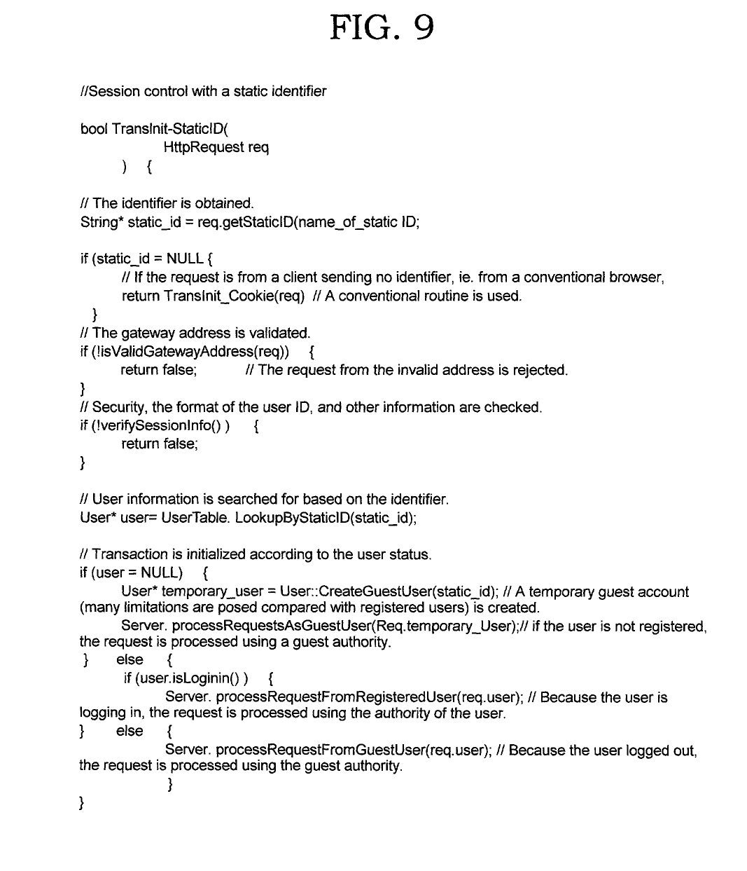

FIG. 9 shows an example of pseudo code which can be used to perform the process from step 802 to step 806 as shown in FIG. 8. The EC server 6 receives an HttpReq from a user, defines the data type of StaticID, which is an identifier in an HttpReq signal, on line “bool TransInit_StaticID(HttpRequest req)” and obtains the identifier on line “String* static_ID=req.getStaticID(name_of_static_ID)”. If the HttpReq is from a user sending an HttpReq containing no identifier, that is, the user of a computer 7, the determination of “If(static_id=NULL)” will be true,and, therefore, “TransInit_Cookie(req)”, which is a conventional process using a Cookie, will be executed.

If the determination of “If(static_id=NULL)” is false, the user has sent the HttpReq through a cellular phone 1, therefore, its gateway address is validated on “if(!isvalidGateway address(req))”. If the gateway address is not an authorized address, false is returned and the request from the invalid address is rejected to prevent the unauthorized access. On the other hand, if it is determined on “if(“!isValidGateway address(req))” that the request is from an authorized gateway address, verifications (such as security information check and the format check of the user ID) are executed on “if(!verifySessionInfo())” to determine whether the HttpReq is from the user of a cellular phone 1.

If it is determined that the HttpReq is from a cellular phone 1, user information stored as a look-up table is searched for that user on “User* user=Usertable.LookupByStaticID(StaticID)”. During this search, if no information about the user is found, it is determined that the access is from a non-registered user. Therefore, a temporary guest account is created on “user* temporary_user=User::CreateGuestUser(static_id)”. Then a server process command is executed using a guest authority on “Server.processRequestsAs GuestUser (Req.temporary_user)”. This guest account allows a user to execute only limited commands compared with a registered user. In addition, this guest account allows a new user to perform a registration.

If user information corresponding to the user is found in the look-up table on the line, “User* user=Usertable. LookupByStaticID (Static ID)”, it is determined whether the user is logging in to the EC server on the line, “if (user.isLoginIn())”. If the user is logging in, “Server.processRequestFromRegisteredUser(req, user)” is used to execute the requested command by using the authority of the user to provide a service, such as a commodity purchasing service. If the user has already been registered but not logged in, “Server.processRequetFrom GuestUser(req, user)” is executed to perform the server process by using a guest authority.

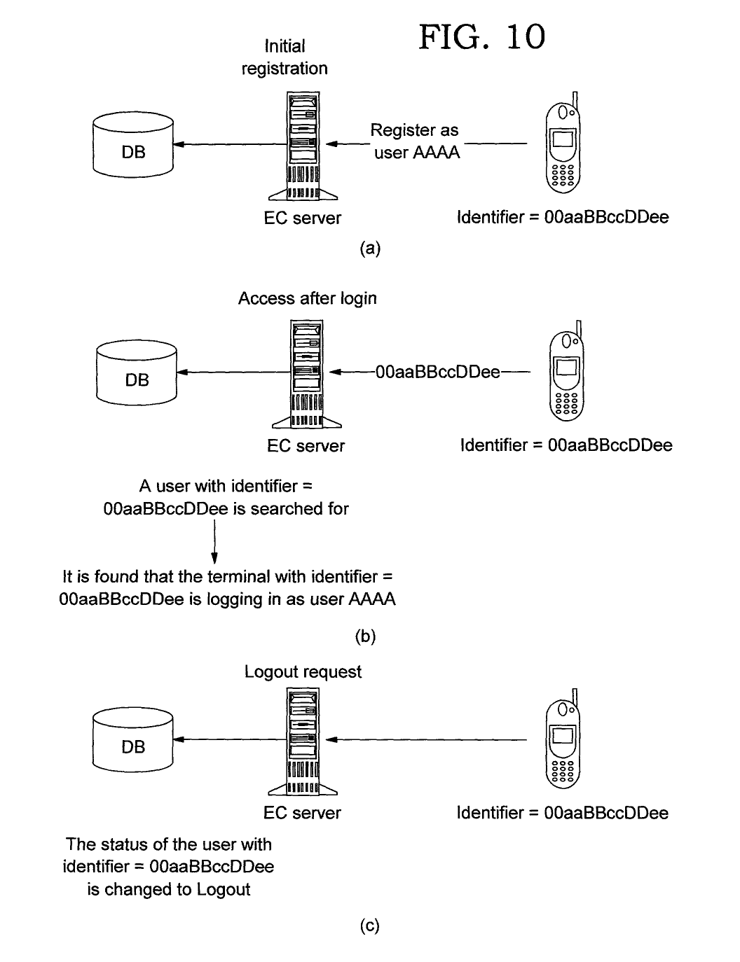

FIG. 10 shows how the commodity purchasing method according to this invention described in detail with reference to FIGS. 8 and 9 is performed between a cellular phone 1 and the EC server 6. As shown in FIG. 10a, identifier 00aaBBccDDee associated with the identification code, which is for example the telephone number, of the cellular phone 1 is assigned to the cellular phone 1. An identifier associated with the identification code is assigned to an HttpReq sent from the cellular phone 1 by a gateway 5 (not shown). In FIG. 10a, the identifier is shown as 00aaBBccDDee. The EC server 6, which receives an HttpReq to which this identifier is assigned, searches a database for the user after determining that the identifier is contained in the HttpReq. Because the user of the cellular phone 1 is not registered with the commodity purchasing system, the user gains access to the EC server 6 as a guest for initial registration. In the user registration, a conventional registration process is performed and, in addition, information shown in Table 1 below is registered on the database recorded on storage means within the EC server 6.

TABLE 1

| User ID | Static_ID (identifier) | Status |
|---|---|---|
| AAAA | OOaaBBccDDee | Login |

Other information may also be registered on the database, if required.

After the registration, as shown in FIG. 10b, the user accesses the EC server 6 and purchase commodities, as needed. In session control during an access after a login, the EC server 6 searches for the user whose Static_ID is 00aaBBccDDee and knows that the user of the cellular phone 1 accessing the EC server 6 is logging in as the user having a user ID, AAA, and a Status_ID (identifier), 00aaBBccDDee.

FIG. 10c shows a process performed when a logout request is issued from the cellular phone 1 to the commodity purchasing system of this invention. The user of the cellular phone 1 sends an appropriate signal for logging out of the EC server 6. The EC server 6 receives the signal, refers to its database, and changes the Status of the user having the Static_ID (identifier), 00aaBBccDDee, from Login to Logout. In this way, the session control for a series of accesses can be performed without sending and receiving history information, such as a Cookie, between the EC server 6 and a computer 7.

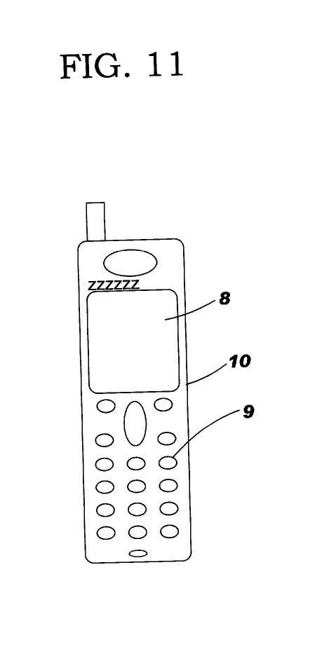

FIG. 11 shows an example of a cellular phone 1 which can be used with this invention. The cellular phone 1 is provided with a liquid-crystal display 8, push buttons 9, and scroll buttons 10 for performing operations. The user of the cellular phone 1 can access an EC server 6 constituting the commodity purchasing system of this invention and view the screen on the liquid-crystal display 8.

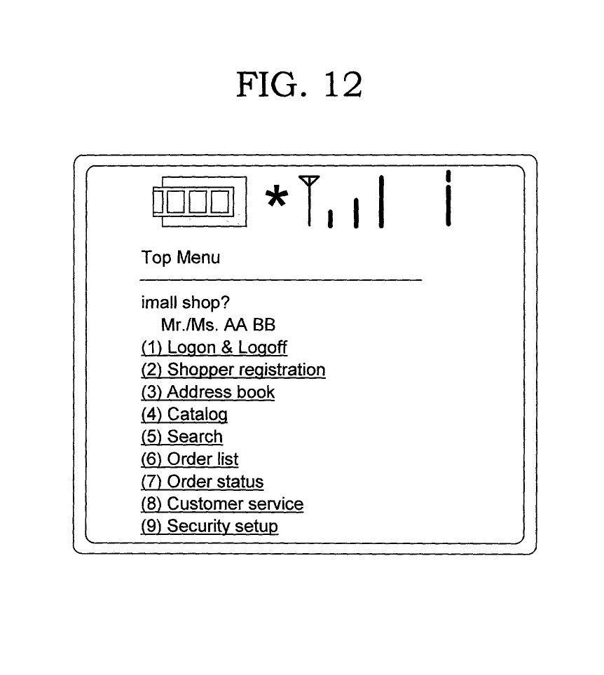

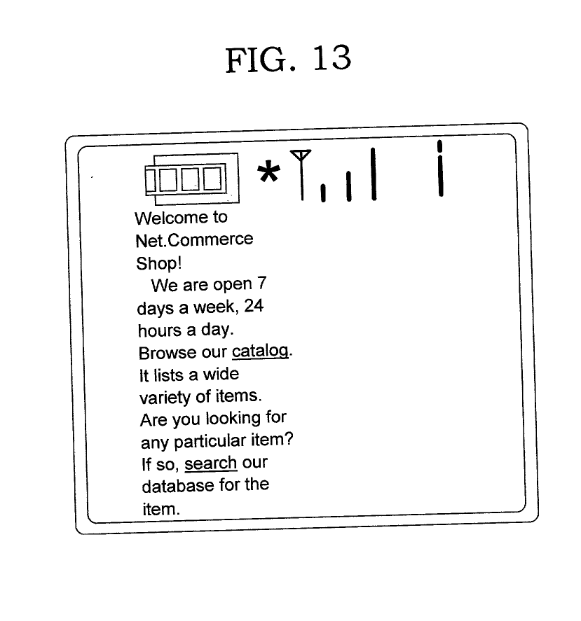

FIG. 12 shows a screen displayed on the liquid-crystal display 8 of a cellular phone 1 in the commodity purchasing system according to this invention. A list of services that the commodity purchasing system can provide is displayed as the top menu on a display screen. A user name retrieved by the telephone number of the cellular phone may also be displayed. The user can operate the push buttons 9 or the scroll buttons 10 to select a desired service. If the user has not been registered with the commodity purchasing system, the user is permitted to access the system by using guest authority.

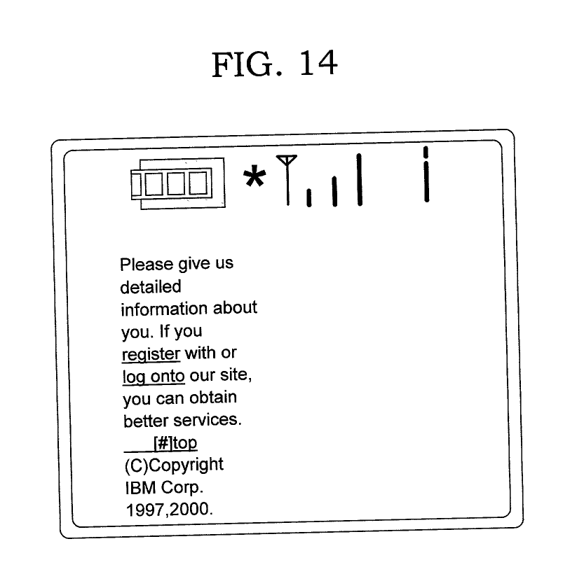

FIG. 13 shows a screen displayed after the user of the cellular phone 1 scrolls the top menu screen shown in FIG. 12. On the screen shown in FIG. 13, services that the commodity purchasing system of this invention can provide are presented to the user who is then prompted to perform an operation according to the information. The user can further scroll the screen to display a registration screen as shown in FIG. 14. If the user of the cellular phone 1 has not been registered with the system, the commodity purchasing services would be made fully available by registering.

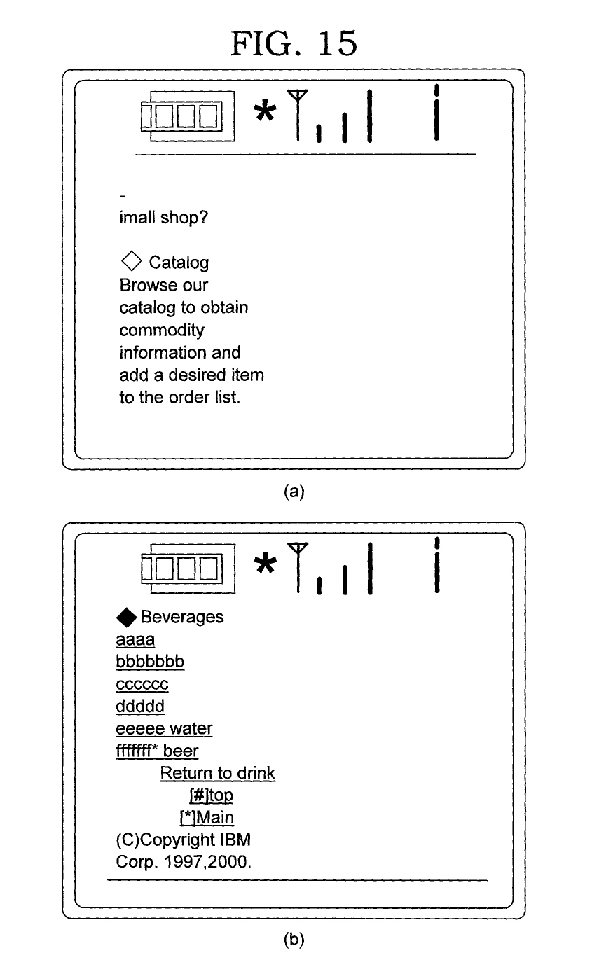

FIG. 15a shows a commodity catalog displayed on the liquid-crystal display 8. When the screen is scrolled, the catalog presents a list of commodity items that the commodity purchasing system can provide, as shown in FIG. 15b. While a catalog of beverages is shown in FIG. 15b, a list of other commodities can be similarly displayed. For example, if the user wants to purchase commodity item bbbbbbb, the user can scroll the screen to position the cursor on to the commodity item bbbbbbb and press a scroll button to choose the commodity item for purchase.

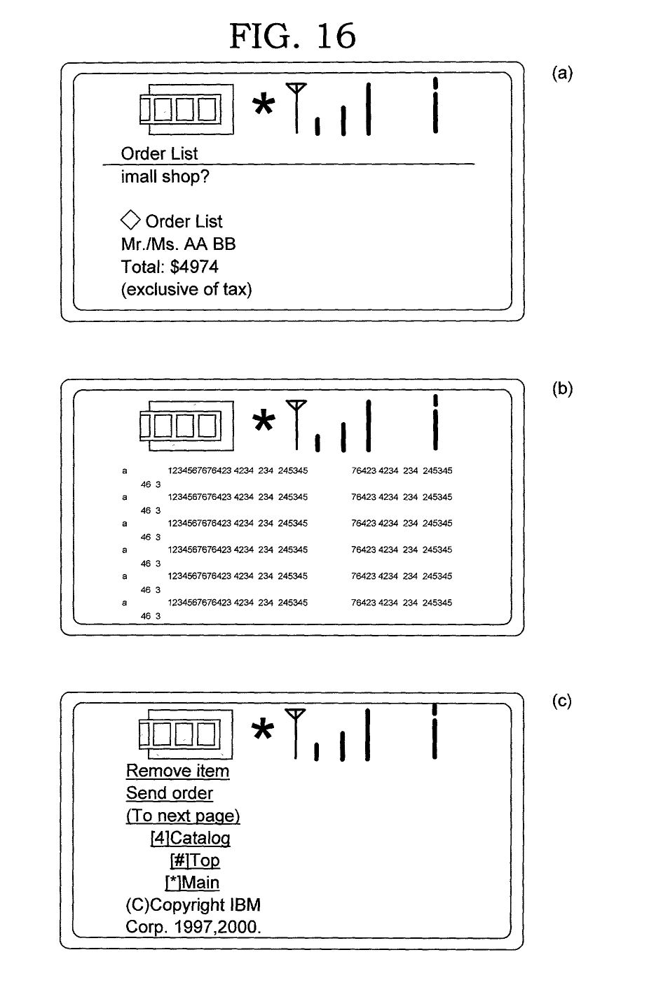

FIGS. 16a, 16b, and 16c show order list screens provided by the commodity purchasing system of this invention. The order list allows the user to know commodities that the user has ordered and the total cost. As shown in FIG. 16c, the user can remove a commodity chosen to purchase. After the user selects a commodity to purchase, the user performs a “send order” operation shown in FIG. 16c to order the commodity from the EC server 6.

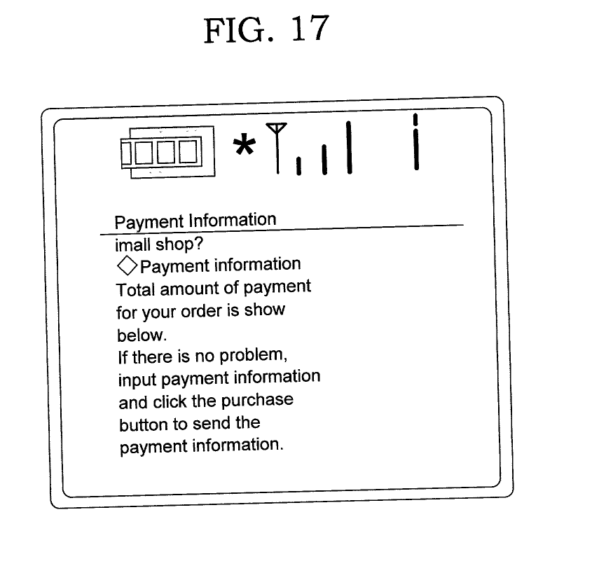

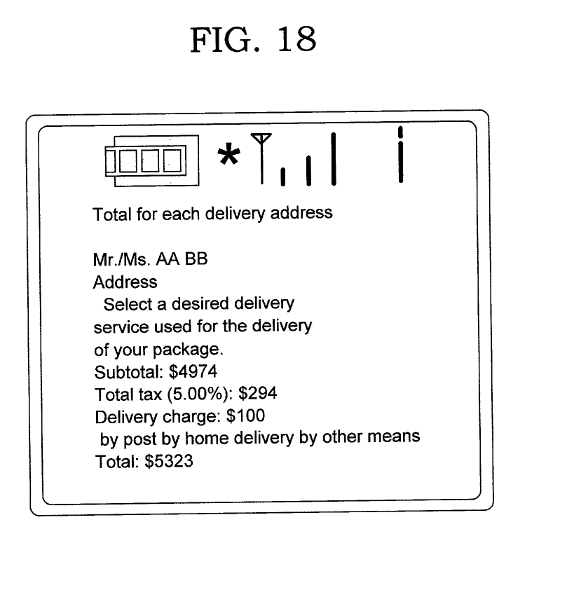

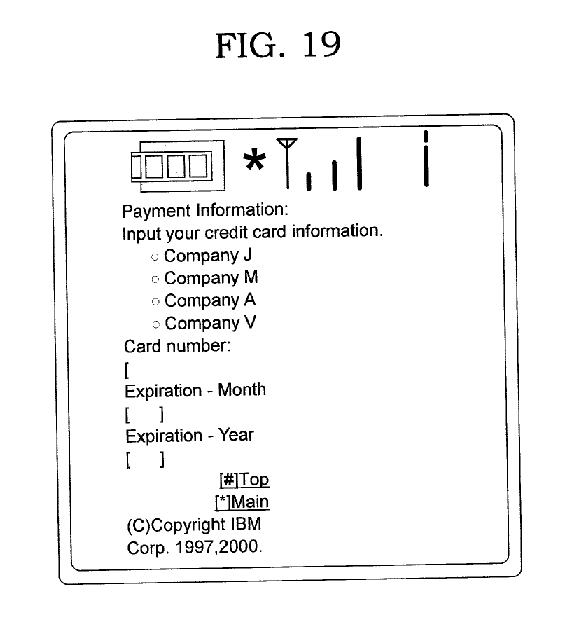

FIG. 17 shows a screen displayed after an order is placed. After the user is prompted to confirm the payment data, information such as the total cost is displayed by, for example, scrolling on the screen, and the user can select and input delivery charge and a delivery service. After this operation is completed and the screen is further scrolled, a screen for inputting a method of payment as shown in FIG. 19 is displayed. The user selects an appropriate payment method and inputs required information such as a credit card number, then sends them to complete the procedure of the commodity purchasing system of this invention. After completion, the user can purchase another commodity through the commodity purchasing system or log out of the system.

While this invention has been described with respect to exemplary embodiments shown in the drawings, this invention is not limited to these embodiments and various other embodiments can be used. In addition, while the commodity purchasing system of this invention has been described in detail with reference to the drawings, this invention also includes a commodity purchasing method performed by the commodity purchasing system described above. The commodity purchasing method can be written in any known conventional object-oriented programming language such as, for example, C language. The program can be recorded on a computer-readable recording medium such as a floppy disk, hard disk, CD-ROM, DVD, magneto-optical disk, and magnetic tape, for example.

What is claimed:

1. A network commodity purchasing system with a unit for receiving a connection request sent from both a computer and a cellular phone and an identifier corresponding to an identification code of the cellular phone, wherein said unit for receiving said connection request comprises:
a unit for determining whether or not said identifier is included ; and
a unit for executing a different session control depending on whether said identifier is included or not.

2. The commodity purchasing system according to claim 1, wherein said unit for receiving said connection request comprises a database on which user information is registered and said database contains said identifier and user status information associated with said identifier.

3. The commodity purchasing system according to claim 2, wherein said unit for executing different session control executes session control by using history information communicated between said system and said computer if it is determined that said identifier is not included, or executes session control by using said identifier and said user status information associated with said identifier if it is determined that said identifier is included.

4. The commodity purchasing system according to claim 3, wherein said network comprises a first network for transmitting a connection request from said computer and a second network for transmitting a connection request from said cellular phone.

5. The commodity purchasing system according to claim 4, further comprising means connected between said first network and said second network for adding said identifier corresponding to said identification code to said connection request sent from said cellular phone.

6. A commodity purchasing method through a network, comprising the steps of:
receiving a connection request sent from a computer and a connection request sent from a cellular phone which includes an identifier corresponding to an identification code of said cellular phone;
determining whether said identifier is included or not;
storing said identifier and user status information associated with said identifier in a database contained in a unit for receiving said connection request; and
executing different session control depending on whether said identifier is included or not.

7. The commodity purchasing method according to claim 6, wherein said step of executing different session control comprises using history information communicated between said system and said computer if it is determined that said identifier is not included, or using said identifier and said user status information if it is determined that said identifier is included.

8. The commodity purchasing method according to claim 7, wherein said network comprises a first network for communicating with said computer and a second network for communicating with said cellular phone and said method further comprises a step of sending the connection request from said cellular phone through said second network.

9. The commodity purchasing method according to claim 8, comprising the step of adding said identifier corresponding to said identification code to said connection request sent from said cellular phone.

10. A computer-readable recording medium on which a program is recorded for a commodity purchasing method through a network, wherein said method comprises the steps of:
receiving a connection request sent from a computer and a connection request which is sent from a cellular phone and includes an identifier corresponding to an identification code of said cellular phone;
determining whether said identifier is included or not;
storing said identifier and user status information associated with said identifier in a database contained in a unit for receiving said connection request; and
executing different session control depending on whether said identifier is included or not.

11. The recording medium according to claim 10, wherein said step of executing different session control comprises using history information communicated between said system and said computer if it is determined that said identifier is not included, or by using said identifier and said user status information if it is determined that said identifier is included.

12. The recording medium according to claim 11, wherein said network comprises a first network for communicating with said computer and a second network for communicating with said cellular phone and said cellular phone sends the connection request through said second network.
